(19) United States
(12) Patent Application Publication
(10) Pub. No.: US 2006/0112211 A1
(43) Pub. Date: May 25, 2006

(54) Method of transporting a PCI express packet over a VMEbus network

(76) Inventors: Douglas L. Sandy, Chandler, AZ (US); Jeffrey M. Harris, Chandler, AZ (US); Robert C. Tufford, Chandler, AZ (US)

Correspondence Address: MOTOROLA, INC., LAW DEPARTMENT, 1303 E. ALGONQUIN ROAD, SCHAUMBURG, IL, 60196, US

(21) Appl. No.: 10/996,890

(22) Filed: Nov. 23, 2004

(51) Int. Cl. G06F 13/36

(52) U.S. Cl. 710/315

(57) ABSTRACT

A method of transporting a PCI Express packet (135) from an initiator PCI Express domain (102) over a VMEbus network (110) to a receiver PCI Express domain (104), can include the initiator PCI Express domain creating the PCI Express packet, while a PCI Express-to-VMEbus encapsulation module (103) reads a first PCI Express destination address (250) of the PCI Express packet. The first PCI Express destination address is mapped to a receiver PCI Express domain VMEbus address (242). The PCI Express packet is encapsulated in a data field (282) of a VMEbus write transaction (236) by the PCI Express-to-VMEbus encapsulation module. The VMEbus write transaction is communicated to the receiver PCI Express domain over the VMEbus network.

### BACKGROUND OF THE INVENTION

Current embedded, data networks, such as parallel multi-drop bus networks, often use VERSAmodule Eurocard (VMEbus) protocols. VMEbus networks can contain payload cards, which have their own network to connect computing elements on the payload card. In the prior art, Peripheral Component Interconnect (PCI) and PCI-X have been used as a general input/output (I/O) standard on VMEbus network cards. However, PCI and PCI-X are beginning to hit the limits of their capabilities. Extensions to the PCI standards, such as 64-bit slots and clock speeds of 66 MHz or 100 MHz, are too costly, and cannot meet the rapidly increasing bandwidth demands in PCs over the next few years.

PCI Express was recently developed to meet this challenge and uses a serial bus architecture. Whether PCI, PCI-X or PCI Express are used, the prior art requires that data be translated between these PCI protocols and the VMEbus protocol so that data generated on the VMEbus payload card using the PCI protocol can be communicated over the VMEbus. The data is then translated back to a PCI protocol from the VMEbus protocol upon arrival at a destination VMEbus payload card. This is time-consuming and costly, with information occasionally being lost in the translation.

Accordingly, there is a significant need for an apparatus and method that overcomes the deficiencies of the prior art outlined above.

### BRIEF DESCRIPTION OF THE DRAWINGS

Referring to the drawing:

FIG. 1 depicts a computer network according to one embodiment of the invention;

FIG. 2 depicts a PCI Express packet encapsulated into a VMEbus write transaction according to an embodiment of the invention;

FIG. 3 depicts a PCI Express packet de-encapsulated from a VMEbus write transaction according to an embodiment of the invention; and

FIG. 4 illustrates a flow diagram of a method of the invention according to an embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings, which illustrate specific exemplary embodiments in which the invention may be practiced. These embodiments are described in sufficient detail to enable those skilled in the art to practice the invention, but other embodiments may be utilized and logical, mechanical, electrical and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

By way of background, Peripheral Component Interconnect (PCI) was developed in the early 1990's as a general I/O architecture to transfer data and instructions faster than the ISA architecture of the time. PCI has gone through several improvements since that time, with the latest proposal being PCI Express. In a nutshell, PCI Express is a replacement of the PCI and PCI-X bus specification to provide platforms with much greater performance, while using a much lower pin count (Note: PCI and PCI-X are parallel bus architectures, PCI Express is a serial bus architecture). A complete discussion of PCI Express is beyond the scope of this specification, but a thorough background and description can be found in the following books which are incorporated herein by reference: Introduction to PCI Express, A Hardware and Software Developer's Guide, by Adam Wilen, Justin Schade, Ron Thornburg; The Complete PCI Express Reference, Design Insights for Hardware and Software Developers, by Edward Solari and Brad Congdon; and PCI Express System Architecture, by Ravi Budruk, Don Anderson, Tom Shanley; all of which are available at www.amazon.com. In addition, the PCI Express specification is managed and disseminated through the Special Interest Group (SIG) for PCI found at www.pcisig.com.

VMEbus as known in the art, can be implemented as a master/slave architecture that uses an asynchronous bus with a variable speed handshaking protocol. VMEbus is defined in the ANSI/VITA 1-1994 and ANSI/VITA 1.1-1997 standards, promulgated by the VMEbus International Trade Association (VITA), P.O. Box 19658, Fountain Hills, Ariz., 85269 (where ANSI stands for American National Standards Institute). In an embodiment of the invention, VMEbus parallel multi-drop protocols can include, but are not limited to, Single Cycle Transfer protocol (SCT), Block Transfer protocol (BLT), Multiplexed Block Transfer protocol (MBLT), Two Edge VMEbus protocol (2eVME) and Two Edge Source Synchronous Transfer protocol (2eSST).

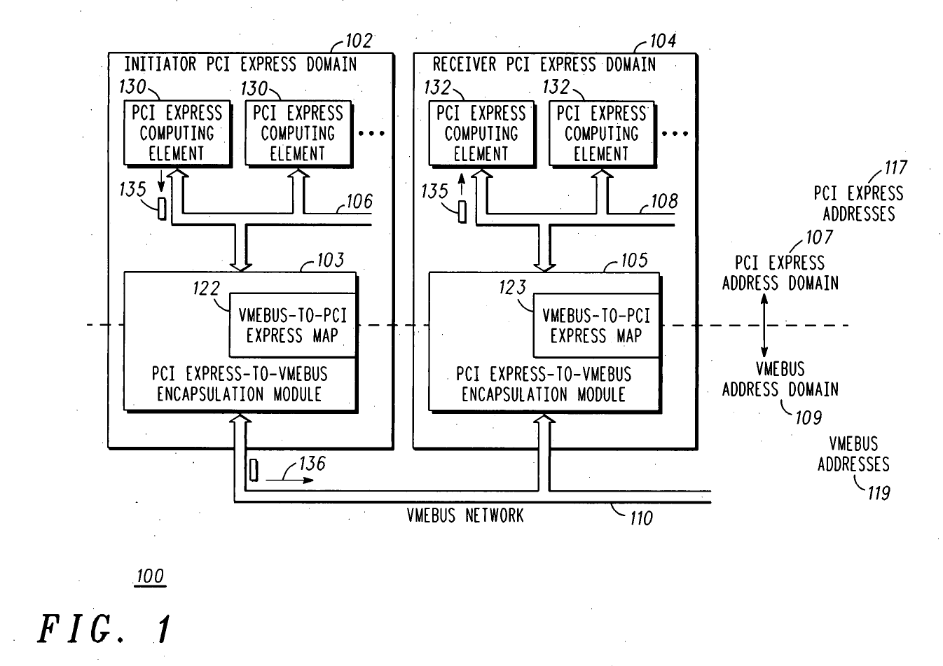

FIG. 1 depicts a computer network 100 according to one embodiment of the invention. Computer network 100 can include any number of PCI Express domains 102, 104 coupled to VMEbus network 110. By way of example, initiator PCI Express domain 102 can be any board, chassis, network or system that includes one or more PCI Express computing elements 130 coupled by a PCI Express network 106. PCI Express computing element 130 can include, but is not limited to, a processor, memory device, storage device, wireline or wireless communication device, and the like. PCI Express computing element 130 is coupled to communicate on PCI Express network 106 using PCI Express packets 135.

In an embodiment, PCI Express packet 135 can be a Transaction Layer Packet (TLP) datagram formatted to be communicated over PCI Express network 106. In an embodiment, each PCI Express computing element 130 is coupled to PCI Express network 106. In an embodiment, PCI Express network 106 is coupled to PCI Express-to-VMEbus encapsulation module 103 which can function to encapsulate and de-encapsulate PCI Express packets 135 in and out of VMEbus write transactions 136 as explained more fully below.

In an embodiment, computer network 100 can include PCI Express address domain 107 comprising a plurality of PCI Express addresses 117. PCI Express addresses 117 are only recognizable and readable within a PCI Express network such as PCI Express network 106 and can include, for example, one or more memory address spaces. For example, PCI Express addresses on initiator PCI Express domain 102 may only be recognizable and relevant to PCI Express computing elements 130 coupled to PCI Express network 106 on initiator PCI Express domain 102 as they reference one or more memory address spaces on initiator PCI Express domain 102. Also, receiver PCI Express domain 104 can have its own set of PCI Express addresses relevant only to PCI Express computing elements 132 coupled to PCI Express network 108 on receiver PCI Express domain 104.

Although PCI Express addresses 117 can be used to specify a destination address for a PCI Express packet going from initiator PCI Express domain 102 to receiver PCI Express domain 104, these PCI Express addresses 117 are not recognizable to VMEbus network 110. Therefore, any PCI Express packet 135 addressed from initiator PCI Express domain 102 to receiver PCI Express domain 104 cannot travel over VMEbus network 110 by itself.

In an embodiment, initiator PCI Express domain 102 can include PCI Express-to-VMEbus encapsulation module 103 coupled to PCI Express network 106 and to VMEbus network 110. In an embodiment, PCI Express-to-VMEbus encapsulation module 103 can include any combination of hardware, software, and the like. PCI Express-to-VMEbus encapsulation module 103 can function to encapsulate a PCI Express packet 135 into a VMEbus write transaction 136 for transport over VMEbus network. PCI Express-to-VMEbus encapsulation module 103 can also function to de-encapsulate a PCI Express packet 135 from VMEbus write transaction 136 so the PCI Express packet 135 can be communicated over PCI Express network 106.

Receiver PCI Express domain 104 can also include any number of PCI Express computing elements 132 coupled by PCI Express network 108. Receiver PCI Express domain 104 can also include PCI Express-to-VMEbus encapsulation module 105 that functions to encapsulate and de-encapsulate a PCI Express packet 135 in a manner analogous to that described with reference to PCI Express-to-VMEbus encapsulation module 103 in initiator PCI Express domain 102.

An exemplary embodiment of a method of initializing computer network 100 will now be described. In an embodiment, upon power-up or boot-up of computer network 100, initiator PCI Express domain 102 can determine a PCI Express address map, which can be for example a list of all PCI Express addresses of each of the PCI Express computing elements 130 on initiator PCI Express domain 102. In an embodiment, the PCI Express address map can be a list of the PCI Express addresses of all PCI Express computing elements 130 capable of sending, receiving, and the like, a PCI Express packet 135. The same procedure can be repeated for receiver PCI Express domain 104 which can generate a PCI Express address map in an analogous manner.

Also upon power-up or initialization of computer network 100, VMEbus addresses 119 in VMEbus domain 109 can be statically determined. VMEbus domain 109 can be the network space where only VMEbus addresses 119 are recognized and transactions using VMEbus protocols are communicated. Each PCI Express domain 102, 104 can have one or more VMEbus addresses assigned to it. For example, any number of blocks of memory can be contained in a VMEbus address. Any number of blocks of memory (as VMEbus addresses) can be assigned to a PCI Express domain. In an embodiment, a VMEbus address can correspond to a memory block in PCI Express network 106, 108, in PCI Express domain 102, 104 respectively. Determining VMEbus addresses 119 at boot-up of computer network 100 is known in the art.

In an embodiment, upon power-up or initialization of computer network 100, each PCI Express domain 102, 104 can map PCI Express addresses 117 to VMEbus addresses 119. As an example, in initiator PCI Express domain 102, the PCI Express addresses of each of the computing elements 130 can be mapped to VMEbus addresses 119, thereby creating VMEbus-to-PCI Express map 122. This mapping can be done in PCI Express-to-VMEbus encapsulation module 103. In an embodiment, VMEbus-to-PCI Express map 122 can be a look-up table, database, list, algorithm, and the like. Receiver PCI Express domain 104 can build VMEbus-to-PCI Express map 123 in an analogous manner. In embodiment, each PCI Express domain coupled to VMEbus network 110 can build a VMEbus-to-PCI Express address map.

The invention is not limited to computer networks having only PCI Express domains. Computer network 100 can include other domains coupled to VMEbus network 110 that function using another protocol besides PCI Express.

An exemplary embodiment of a method of transporting a PCI Express packet 135 from initiator PCI Express domain 102, over VMEbus network 110, to receiver PCI Express domain 104 will now be described. PCI Express network 106 is coupled to PCI Express-to-VMEbus encapsulation module 103, which is coupled to encapsulate a PCI Express packet 135 into a VMEbus write transaction 136 for transport over VMEbus network 110. PCI Express-to-VMEbus encapsulation module 103 can also function to de-encapsulate a PCI Express packet 135 from VMEbus write transaction 136 so the PCI Express packet 135 can be communicated over PCI Express network 106.

Receiver PCI Express domain 104 can include one or more PCI Express computing elements 132. PCI Express computing element 132 is coupled to communicate on PCI Express network 108 using PCI Express packet 135. In an embodiment, PCI Express packet 135 can be a Transaction Layer Packet (TLP) datagram formatted to be communicated over PCI Express network 108. PCI Express network 108 is coupled to PCI Express-to-VMEbus encapsulation module 105, which is coupled to encapsulate a PCI Express packet 135 into VMEbus write transaction 136 for transport over VMEbus network 110. PCI Express-to-VMEbus encapsulation module 105 can also function to de-encapsulate a PCI Express packet 135 from a VMEbus write transaction 136 so the PCI Express packet 135 can be communicated over PCI Express network 108.

As described above, VMEbus-to-PCI Express map 122, 123 can be determined at PCI Express domain 102, 104 respectively. In an embodiment, PCI Express computing element 130 at initiator PCI Express domain 102 can create PCI Express packet 135. In an embodiment, PCI Express packet 135 can include a PCI Express destination address such that PCI Express packet 135 is addressed to one of PCI Express computing elements 132 on receiver PCI Express domain 104. In this embodiment, PCI Express packet 135 is required to traverse VMEbus network 110.

PCI Express packet 135 can be communicated over PCI Express network 106 in initiator PCI Express domain 102 to PCI Express-to-VMEbus encapsulation module 103, where the PCI Express destination address is read. In an embodiment, PCI Express-to-VMEbus encapsulation module 103 can use VMEbus-to-PCI Express map 122 to map the PCI Express destination address to a receiver PCI Express domain VMEbus address. In an embodiment, receiver PCI Express domain VMEbus address can be included in an address field of VMEbus write transaction 136. In accordance with mapping, PCI Express packet 135 can be encapsulated in the data field of VMEbus write transaction 136, where VMEbus write transaction 136 is communicated to receiver PCI Express domain 104 over VMEbus network 110. This is contrasted with the prior art where the entire PCI Express packet is translated into VMEbus protocol for transit over VMEbus network.

In an embodiment, upon receipt of VMEbus write transaction 136 at receiver PCI Express domain 104, PCI Express-to-VMEbus encapsulation module 105 can de-encapsulate PCI Express packet 135 from VMEbus write transaction 136. Thereafter, PCI Express packet 135 can be issued via PCI Express network 108 to PCI Express computing element 132.

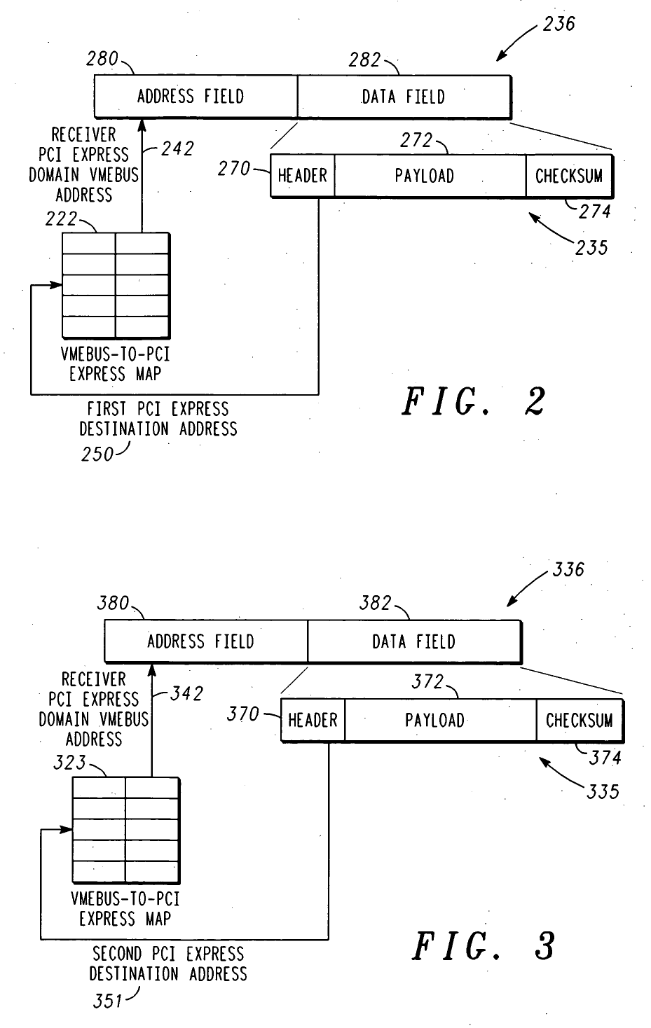

FIG. 2 depicts a PCI Express packet 235 encapsulated into a VMEbus write transaction 236 according to an embodiment of the invention. In an embodiment, the VMEbus write transaction can include a request signal from initiator PCI Express domain 102 to receiver PCI Express domain 104 that includes data to be written from initiator PCI Express domain 102 to receiver PCI Express domain 104. If the PCI Express computing element 132 at receiver PCI Express domain 104 recognizes request signal, receiver PCI Express domain 104 can communicate response signal back to initiator PCI Express domain 102 to indicate that data has been written.

VMEbus write transaction 236 can include address field 280, which can include receiver PCI Express domain VMEbus address 242, protocol to be used, and the like. For example, address field 280 can include data from a VMEbus encoding table as is known in the art. For example, VMEbus encoding table can include the geographic address, slot number, and the like. Address field 280 can be formatted using extended address modifier (XAM) code. XAM code in general is known in the art. Data field 282 can include the data being transported by VMEbus write transaction 236. In an embodiment, an XAM code can be included in the address field to flag what type of packet is encapsulated in data field 282. For example, an XAM code can be included in address field 280 to indicate that a PCI Express packet is encapsulated in the data field 282 of the VMEbus write transaction 236.

PCI Express packet 235 can include header portion 270, which can include first PCI Express destination address 250. Payload 272 can include the data being transported by PCI Express packet 235. Checksum 274 ensures PCI Express packet integrity.

In an embodiment, PCI Express packet 235 can be created by PCI Express computing element 130 in initiator PCI Express domain 102 as described above. In one embodiment, PCI Express packet 235 can include first PCI Express destination address 250 in header portion 270. In an embodiment, PCI Express-to-VMEbus encapsulation module 103 can include VMEbus-to-PCI Express map 222 to map first PCI Express destination address 250 to receiver PCI Express domain VMEbus address 242. In an embodiment, receiver PCI Express domain VMEbus address 242 is placed address field 280 such that VMEbus write transaction 236 is addressed to receiver PCI Express domain 104. In other words, VMEbus write transaction 236 is addressed to receiver PCI Express domain 104 having PCI Express computing element 132 to which PCI Express packet 235 is destined. PCI Express packet 235 can then be encapsulated in data field 282 of VMEbus write transaction 236 as shown in FIG. 2.

FIG. 3 depicts a PCI Express packet 335 de-encapsulated from a VMEbus write transaction 336 according to an embodiment of the invention. Like elements in FIG. 2 have like numbers as shown in FIG. 3. In an embodiment where receiver PCI Express domain 104 determines that VMEbus write transaction 336 is addressed to it, receiver PCI Express domain 104 can claim VMEbus write transaction 336.

When VMEbus write transaction 336 arrives at receiver PCI Express domain 104, the reverse of the above process can occur. For example, PCI Express-to-VMEbus encapsulation module 105 at receiver PCI Express domain 104 can use VMEbus-to-PCI Express map 323 to de-encapsulate PCI Express packet 335 and map receiver PCI Express domain VMEbus address 342 back to second PCI Express destination address 351. Thereafter, PCI Express packet 335 can be issued over PCI Express network 108 to PCI Express computing element 132. In an embodiment where PCI Express addresses are in a flat address space configuration, first PCI Express destination address 250 can be identical to second PCI Express destination address 351. In an embodiment where PCI Express addresses are not in a flat address space configuration, first PCI Express destination address 250 can be different from second PCI Express destination address 351.

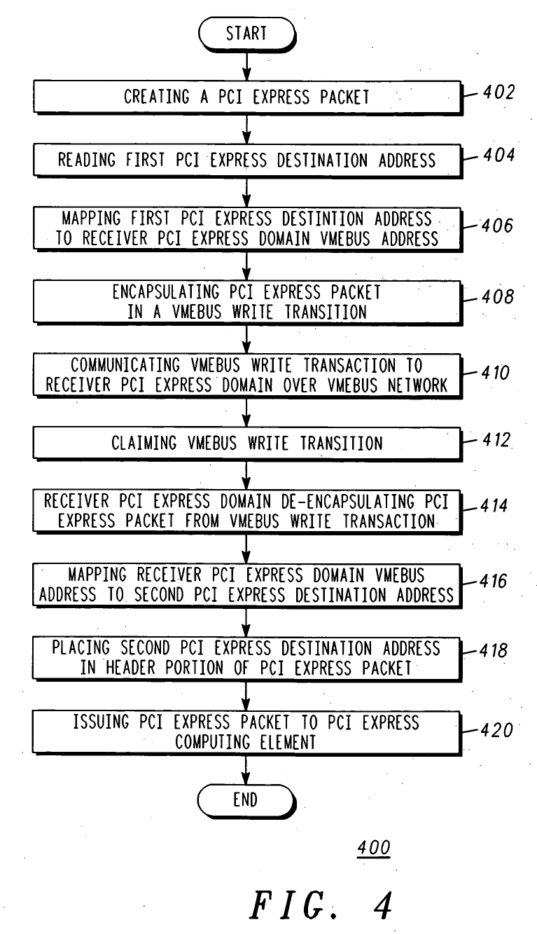

FIG. 4 illustrates a flow diagram 400 of a method of the invention according to an embodiment of the invention. In an embodiment, FIG. 4 sets forth a method of transporting a PCI Express packet from an initiator PCI Express domain, over a VMEbus network, to a receiver PCI Express domain. In step 402, a PCI Express packet is created by a PCI Express computing element at initiator PCI Express domain. In step 404, a PCI Express-to-VMEbus encapsulation module can read first PCI Express destination address from PCI Express packet.

In step 406, VMEbus-to-PCI Express map at initiator PCI Express domain can be used to map first PCI Express destination address to a receiver PCI Express domain VMEbus address. In step 408, PCI Express packet can be encapsulated in VMEbus write transaction. In step 410, VMEbus write transaction can be communicated over VMEbus network to receiver PCI Express domain. In step 412, VMEbus write transaction can be claimed by receiver PCI Express domain. In step 414, PCI Express packet can be de-encapsulated from VMEbus write transaction at PCI Express-to-VMEbus encapsulation module at receiver PCI Express domain.

In step 416, VMEbus-to-PCI Express map at receiver PCI Express domain can be used to map receiver PCI Express domain VMEbus address to a second PCI Express destination address. In step 418, second PCI Express destination address can be placed in header portion of PCI Express packet. In step 420, PCI Express packet can be issued to a PCI Express computing element over a PCI Express network on receiver PCI Express domain.

While we have shown and described specific embodiments of the present invention, further modifications and improvements will occur to those skilled in the art. It is therefore, to be understood that appended claims are intended to cover all such modifications and changes as fall within the true spirit and scope of the invention.

1. In a computer network, a method of transporting a PCI Express packet from an initiator PCI Express domain over a VMEbus network to a receiver PCI Express domain, comprising:
the initiator PCI Express domain creating the PCI Express packet;
reading a first PCI Express destination address of the PCI Express packet;
mapping the first PCI Express destination address to a receiver PCI Express domain VMEbus address;
encapsulating the PCI Express packet in a data field of a VMEbus write transaction; and
communicating the VMEbus write transaction to the receiver PCI Express domain over the VMEbus network.

2. The method of claim 1, further comprising:
the receiver PCI Express domain deciding to claim the VMEbus write transaction;
the receiver PCI Express domain de-encapsulating the PCI Express packet from the data field of the VMEbus write transaction; and
issuing the PCI Express packet to a PCI Express computing element.

3. The method of claim 2, wherein deciding to claim the VMEbus write transaction comprises reading a VMEbus-to-PCI Express map.

4. The method of claim 2, further comprising:
mapping the receiver PCI Express domain VMEbus address to a second PCI Express destination address; and
placing the second PCI Express destination address in a header portion of the PCI Express packet.

5. The method of claim 4, wherein the first PCI Express destination address is identical to the second PCI Express destination address.

6. The method of claim 4, wherein the first PCI Express destination address is different than the second PCI Express destination address.

7. The method of claim 1, further comprising placing the receiver PCI Express domain VMEbus address into an address field of the VMEbus write transaction.

8. A PCI Express domain, comprising:
a PCI Express network; and
a PCI Express-to-VMEbus encapsulation module coupled to the PCI Express network, wherein the PCI Express-to-VMEbus encapsulation module couples the PCI Express domain to an VMEbus network, wherein the PCI Express-to-VMEbus encapsulation module is coupled to map a PCI Express destination address to a receiver PCI Express domain VMEbus address, and wherein the PCI Express-to-VMEbus encapsulation module is coupled to encapsulate a PCI Express packet into a data field of a VMEbus write transaction.

9. The PCI Express domain of claim 8, wherein the PCI Express-to-VMEbus encapsulation module is coupled to communicate the VMEbus write transaction to a receiver PCI Express domain over the VMEbus network.

10. A PCI Express domain, comprising:
a PCI Express network having at least one PCI Express computing element; and
a PCI Express-to-VMEbus encapsulation module coupled to the PCI Express network, wherein the PCI Express-to-VMEbus encapsulation module couples the PCI Express domain to an VMEbus network, wherein the PCI Express-to-VMEbus encapsulation module reads a VMEbus-to-PCI Express map to claim a VMEbus write transaction from the VMEbus network, wherein the PCI Express-to-VMEbus encapsulation module de-encapsulates a PCI Express packet from a data field of the VMEbus write transaction, and wherein the PCI Express-to-VMEbus encapsulation module issues the PCI Express packet on the PCI Express network.

11. The PCI Express domain of claim 10, wherein the PCI Express-to-VMEbus encapsulation module maps a VMEbus address to a PCI Express destination address.

12. The PCI Express domain of claim 10, wherein the PCI Express-to-VMEbus encapsulation module places the PCI Express destination address in a header portion of the PCI Express packet.

13. In a PCI Express domain, a method of communicating a PCI Express packet over a VMEbus network, comprising:
creating the PCI Express packet;
reading a first PCI Express destination address of the PCI Express packet;
mapping the first PCI Express destination address to a receiver PCI Express domain VMEbus address;
encapsulating the PCI Express packet in a data field of a VMEbus write transaction; and
communicating the VMEbus write transaction to a receiver PCI Express domain over the VMEbus network.

14. The PCI Express domain of claim 13, further comprising placing the receiver PCI Express domain VMEbus address into an address field of the VMEbus write transaction.

15. In a PCI Express domain, a method of communicating a PCI Express packet over a VMEbus network, comprising:
the PCI Express domain deciding to claim a VMEbus write transaction from the VMEbus network;
de-encapsulating the PCI Express packet from a data field of the VMEbus write transaction; and
issuing the PCI Express packet to a PCI Express computing element having a PCI Express destination address.

16. The PCI Express domain of claim 15, wherein deciding to claim the VMEbus write transaction comprises reading a VMEbus-to-PCI Express map.

17. A computer-readable medium containing computer instructions for instructing a processor to perform a method of transporting a PCI Express packet from an initiator PCI Express domain over a VMEbus network to a receiver PCI Express domain, the instructions comprising:
the initiator PCI Express domain creating the PCI Express packet;
reading a first PCI Express destination address of the PCI Express packet;
mapping the first PCI Express destination address to a receiver PCI Express domain VMEbus address;
encapsulating the PCI Express packet in a data field of a VMEbus write transaction; and
communicating the VMEbus write transaction to the receiver PCI Express domain over the VMEbus network.

18. The computer-readable medium of claim 17, further comprising:
the receiver PCI Express domain deciding to claim the VMEbus write transaction;
the receiver PCI Express domain de-encapsulating the PCI Express packet from the data field of the VMEbus write transaction; and
issuing the PCI Express packet to a PCI Express computing element.

19. The computer-readable medium of claim 18, wherein deciding to claim the VMEbus write transaction comprises reading a VMEbus-to-PCI Express map.

20. The computer-readable medium of claim 18, further comprising:
mapping the receiver PCI Express domain VMEbus address to a second PCI Express destination address; and
placing the second PCI Express destination address in a header portion of the PCI Express packet.

21. The computer-readable medium of claim 20, wherein the first PCI Express destination address is identical to the second PCI Express destination address.

22. The computer-readable medium of claim 20, wherein the first PCI Express destination address is different than the second PCI Express destination address.

23. The computer-readable medium of claim 18, further comprising placing the receiver PCI Express domain VMEbus address into an address field of the VMEbus write transaction.
